(19) United States
(12) Patent Application Publication
(10) Pub. No.: US 2026/0011966 A1
(43) Pub. Date: Jan. 8, 2026

(54) ROTATABLE PLUG

(71) Applicant: Zhiyong Hu, Shenzhen (CN)

(72) Inventor: Zhiyong Hu, Shenzhen (CN)

(21) Appl. No.: 18/929,765

(22) Filed: Oct. 29, 2024

(30) Foreign Application Priority Data
Jul. 2, 2024 (CN) 202421546617.9

(51) Int. Cl. H01R 39/02; H01R 13/652; H01R 24/28

(52) U.S. Cl. CPC H01R 39/02; H01R 13/652; H01R 24/28

(57) ABSTRACT

The present disclosure provides a rotatable plug, including a base and a plug portion, where the base is electrically connected to the plug portion and the plug portion rotates relative to the base, and the plug portion is provided with a first pin and a second pin; and an accommodating cavity is arranged in the base, and is provided with a rotating member, a first metal conductor and a second metal conductor, where the rotating member includes a rotating shaft, one end of the rotating shaft is fixed to the base, and the other end thereof is connected to the plug portion.

### CROSS-REFERENCE TO RELATED APPLICATION

This application claims priority of Chinese Patent Application No. 202421546617.9, filed on Jul. 2, 2024, the entire contents of which are incorporated herein by reference.

### TECHNICAL FIELD

The present disclosure relates to the technical field of plugs, and particularly relates to a rotatable plug.

### BACKGROUND

With the social development, technological advance, and continuous improvement of people's living standards, more and more electronic devices have been applied to industrial production and daily life. To connect an electronic device to a power supply, a plug on the electronic device is usually inserted into an external socket to make them electrically conductive and connected. The plug on the electronic device plays a crucial role in this process. The plug is internally provided with a live wire and a neutral wire, while a three-phase plug is further provided with a ground wire. The three-phase plugs serve to better ensure the safety of users using electronic devices with metal housings and prevent them from casualty accidents caused by electric shock due to electric leakage.

Pins of a two-phase or three-phase plug in the prior art are fixed relative to a housing and cannot be rotated. To match jacks on the socket, the plug usually needs to be inserted into the socket in a certain direction. In this case, the wire stock on the plug will rotate or bend to a certain extent, which easily damages and even breaks the wire stock, thereby causing serious safety hazards, and affecting the plug's durability and quality. As a result, the plug has a short service life, and brings inconvenience and a poor user experience to the user, thus failing to meet current needs. Therefore, it is necessary to provide a new technical solution to improve the plugs in the prior art through innovations.

### SUMMARY

In order to solve the above technical problems, the present disclosure provides a rotatable plug. The rotatable plug includes a base and a plug portion, where the base is electrically connected to the plug portion and the plug portion rotates relative to the base. The plug portion is provided with a first pin and a second pin. An accommodating cavity is arranged in the base, and the accommodating cavity is provided with a rotating member, a first metal conductor and a second metal conductor, where the rotating member includes a rotating shaft, one end of the rotating shaft is fixed to the base, and the other end thereof is connected to the plug portion. The first metal conductor and the second metal conductor are both of an annular structure and arranged around the rotating shaft as a center. The first pin extends into the accommodating cavity and is in contact with the first metal conductor, while the second metal conductor extends into the accommodating cavity and is in contact with the second metal conductor.

In some embodiments, the plug portion is further provided with a ground pin, and the accommodating cavity is further provided with a ground conductor, where the ground conductor is of an annular structure, and the ground pin extends into the accommodating cavity and is in contact with the ground conductor.

In some embodiments, the second metal conductor, the first metal conductor, and the ground conductor are arranged from near to far in sequence, with the rotating shaft as the center.

In some embodiments, the second pin is fixed on the rotating shaft, the second metal conductor is sleeved on the rotating shaft, and the second pin is in contact with the second metal conductor.

In some embodiments, the first metal conductor is provided with a plurality of elastic members, where the elastic members are located below the first metal conductor and arranged along a direction of the first metal conductor; and the first pin extends and is in contact with the first metal conductor, and an elastic support is formed by the elastic members below the first metal conductor, so that the first pin and the first metal conductor contact each other to form a compacted state.

In some embodiments, the ground pin is connected to a metal elastic sheet, and an end of the metal elastic sheet can move along the ground conductor and is electrically connected with the ground conductor.

In some embodiments, the first metal conductor and the second metal conductor are of a closed annular structure or a non-closed annular structure or a crescent-shaped structure, and the ground conductor is of an annular structure.

In some embodiments, the first metal conductor is a non-closed annular conductive sheet.

In some embodiments, the second metal conductor is a non-closed annular conductive sheet.

In some embodiments, the ground conductor is a closed annular conductive sheet.

For the rotatable plug of the present disclosure, a direction of inserting the plug can be flexibly adjusted by rotating the plug portion. The pins of the plug are aligned with directions of socket jacks, so that the first pin, the second pin, and the ground pin of the plug can be smoothly inserted into corresponding jacks on the socket in any direction. In this way, the present disclosure can effectively avoid rotation or bending of wire stock on the plug, and is not likely to cause damage or even breakage of the wire stock, thus improving the safety performance and making it suitable for different scenarios. Further, after the plug is inserted into the socket, the wire stock and a housing can also rotate around a rotating member. Even if the wire stock rotates during use, the connection between the plug and the socket will not be affected, that is, use thereof is more convenient and flexible.

### BRIEF DESCRIPTION OF THE DRAWINGS

FIG. 1A is a schematic diagram (I) of an overall structure of a rotatable plug in an embodiment of the present disclosure.

FIG. 1B is a sectional view of FIG. 1A in an embodiment of the present disclosure.

FIG. 2 is a schematic diagram (II) of an overall structure of a rotatable plug in an embodiment of the present disclosure.

FIG. 3 is a structural schematic diagram of a plug portion in an embodiment of the present disclosure.

FIG. 4 is a structural schematic diagram (I) of a bottom of a plug portion in an embodiment of the present disclosure.

FIG. 5 is a structural schematic diagram of a front side of a plug portion in an embodiment of the present disclosure.

FIG. 6 is a schematic diagram of a connection structure of a first pin in an embodiment of the present disclosure.

FIG. 7 is a schematic diagram of a connection structure of a ground pin in an embodiment of the present disclosure.

FIG. 8 is a structural schematic diagram (II) of a bottom of a plug portion in an embodiment of the present disclosure.

Reference numerals in figures:
Base 10, plug portion 20, first pin 30, second pin 40, ground pin 50, elastic member 301, rotating shaft 60, first metal conductor 31, second metal conductor 41, ground conductor 51, and metal elastic sheet 52.

### DETAILED DESCRIPTIONS OF THE EMBODIMENTS

In order to make objectives, technical solutions and advantages of the present disclosure clearer, the present disclosure will be described in further detail below with reference to the accompanying drawings and embodiments. It should be understood that specific embodiments described herein are merely used to explain the present disclosure, and are not used to limit the present disclosure. Further, technical features involved in various embodiments of the present disclosure described below can be combined as long as they do not conflict with each other.

A rotatable plug of the present disclosure includes a base 10 and a plug portion 20, where the base 10 is electrically connected to the plug portion 20 and the plug portion 20 rotates relative to the base 10. The plug portion 20 is provided with a first pin 30, a second pin 40, and a ground pin 50. To meet different needs of use, a direction of inserting the plug can be flexibly adjusted by rotating the plug portion 20. The pins of the plug are aligned with directions of socket jacks, so that the first pin 30, the second pin 40, and the ground pin 50 of the plug can be smoothly inserted into corresponding jacks on the socket in any direction. In this way, the present disclosure can effectively avoid rotation or bending of wire stock on the plug, and is not likely to cause damage or even breakage of the wire stock, thus improving the safety performance and making it suitable for different scenarios. Further, after the plug is inserted into the socket, the wire stock and a housing can also rotate around a rotating member. Even if the wire stock rotates during use, the connection between the plug and socket will not be affected, that is, use thereof is more convenient and flexible. The rotatable plug of the present disclosure will be described in detail below.

In the present disclosure, a three-phase plug is taken as an example, and the technical solution of the present disclosure is also applicable to two-phase plugs.

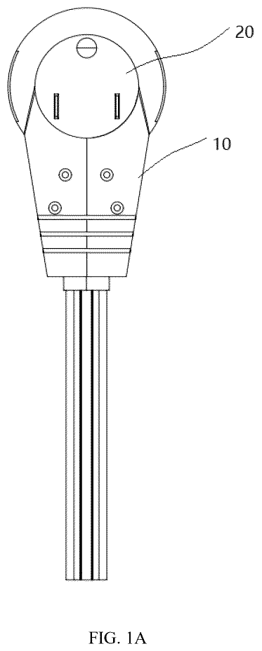

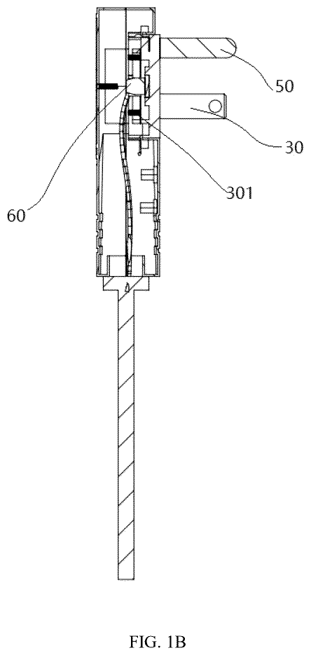

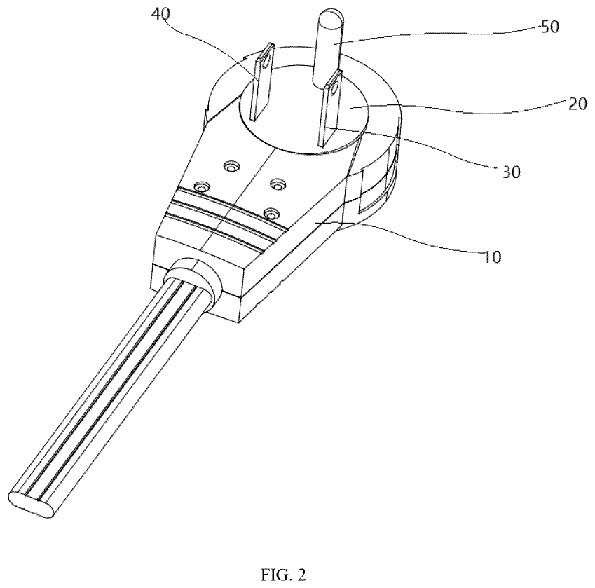

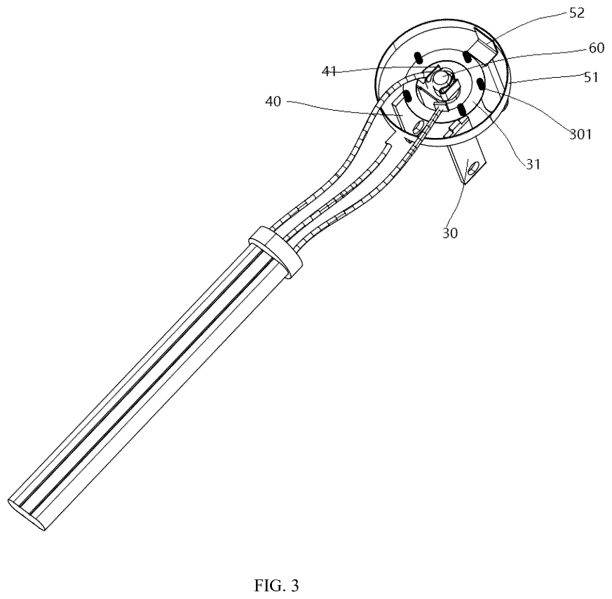

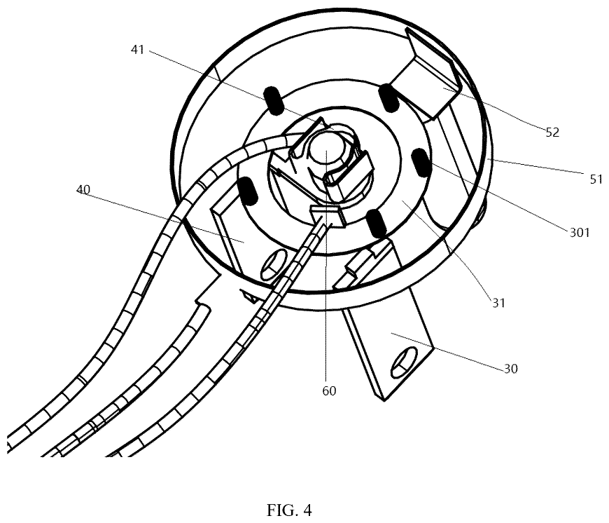

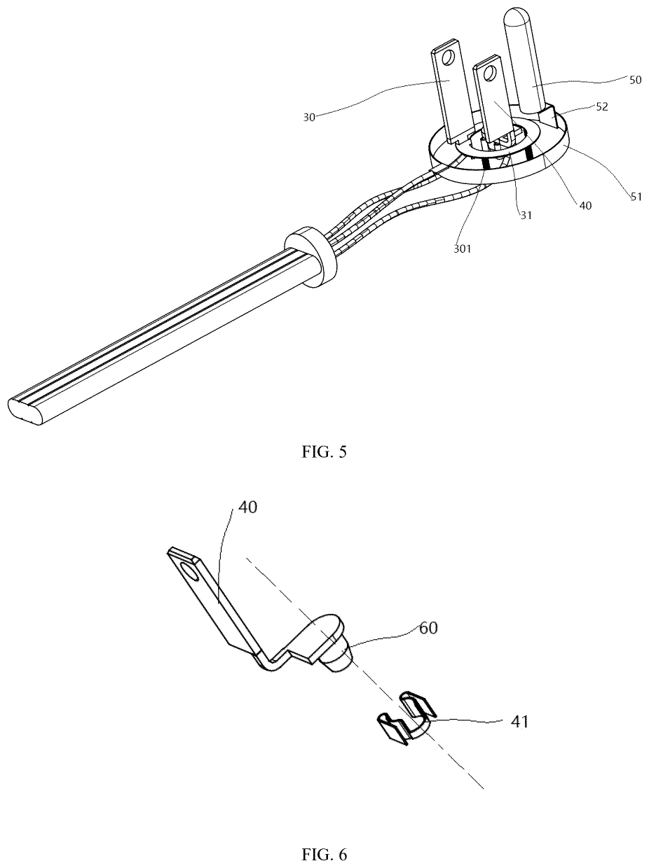

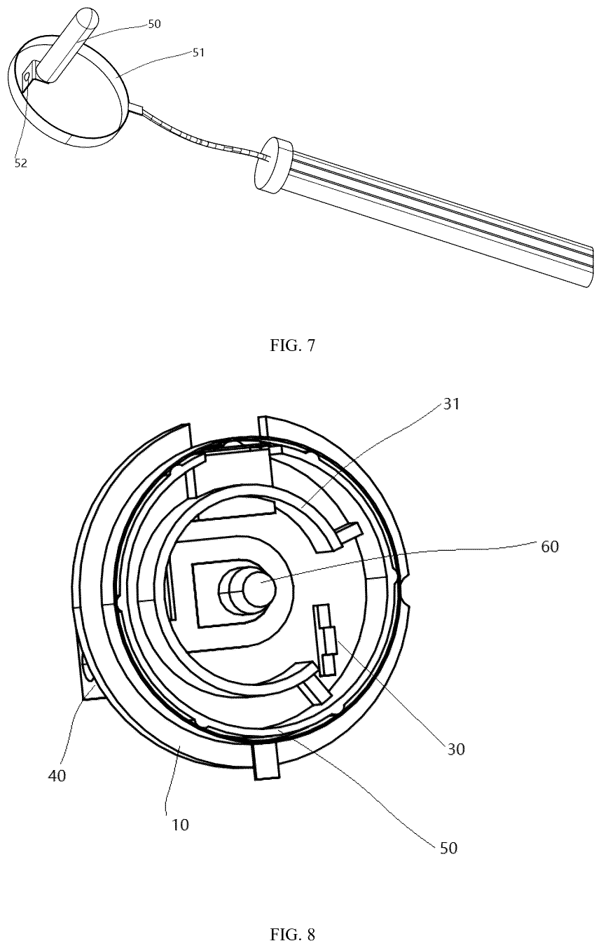

As shown in FIGS. 1-8, a rotatable plug of the present disclosure includes a base 10 and a plug portion 20, where the plug portion 20 serves as a front housing and the base 10 serves as a rear housing, the front housing and the rear housing are connected in a buckled manner, and the base 10 and the plug portion 20 are connected in a buckled manner to form an accommodating cavity. The base 10 is electrically connected to the plug portion 20 and the plug portion 20 rotates relative to the base 10. The plug portion 20 is provided with a first pin 30, a second pin 40, and a ground pin 50. The accommodating cavity is arranged in the base 10, and is provided with a rotating member, a first metal conductor 31, a second metal conductor 41, and a ground conductor 51. The rotating member includes a rotating shaft, one end of the rotating shaft is fixed to the base 10, and the other end thereof is connected to the plug portion 20. The first metal conductor 31, the second metal conductor 41, and the ground conductor 51 are all of an annular structure and arranged around the rotating shaft as a center. The first pin 30 extends into the accommodating cavity and is in contact with the first metal conductor 31, while the second metal conductor 41 extends into the accommodating cavity and is in contact with the second metal conductor 41, and the ground pin 50 extends into the accommodating cavity and is in contact with the ground conductor 51.

In some embodiments, the second metal conductor 41, the first metal conductor 31, and the ground conductor 51 are arranged from near to far in sequence, with the rotating shaft as the center. That is, the ground conductor 51 is located in an outermost layer, the second metal conductor 41 is located in a middle-most layer, and the first metal conductor 31 is located between the ground conductor 51 and the second metal conductor 41. The first metal conductor 31 and the second metal conductor 41 are of a closed annular structure or a non-closed annular structure or a crescent-shaped structure.

As a preferred solution, the first metal conductor 31 is a first annular conductive sheet, and the first metal conductor 31 is provided with a plurality of elastic members 301, where the elastic members 301 are located below the first metal conductor 31 and arranged along a direction of the first metal conductor 31. The first pin 30 extends and is in contact with the first metal conductor 31, and an elastic support is formed by the elastic members 301 below the first metal conductor 31, so that the first pin 30 and the first metal conductor 31 contact each other to form a compacted state. As shown in the accompanying drawings, the first annular conductive sheet is of a non-closed annular structure and has a fracture, and the first pin 30 is located in an opening end portion of the first annular conductive sheet.

The second pin 40 is fixed on the rotating shaft, the second metal conductor 41 is sleeved on the rotating shaft, and the second pin 40 is in contact with the second metal conductor 41. As a preferred solution, the second metal conductor 41 is a second annular conductive sheet. As shown in the accompanying drawings of the present disclosure, the second annular conductive sheet is of a non-closed annular structure or a closed annular structure or a crescent-shaped structure of course.

As a preferred solution, the ground conductor 51 is a third annular conductive sheet. As shown in the accompanying drawings of the present disclosure, the third annular conductive sheet is of a fully closed annular structure, the ground pin 50 is connected to a metal elastic sheet 52, and an end of the metal elastic sheet 52 can move along the ground conductor 51 and is electrically connected with the ground conductor 51.

Further, the present disclosure with the structure of the first annular conductive sheet and the second annular conductive sheet is capable of reducing the volume of the plug overall and minimizing the plug design, thereby facilitating use of the plug in different spaces. The first metal conductor 31 and the second metal conductor 41 are of a closed annular structure or a non-closed annular structure or a crescent-shaped structure. The first pin 30 is a live pin or a neutral pin, and the ground pin 50 is a neutral pin.

The plug of the present disclosure enables the ground pin, the live pin, and the neutral pin to rotate by 360 degrees relative to the housing. When the plug is inserted into the socket, a direction of inserting the plug can be flexibly adjusted by rotating the rotating member, so that the ground pin, the live pin, and the neutral pin thereon can be smoothly inserted into corresponding jacks on the socket in any direction.

Those skilled in the art will readily understand that the above are merely preferred embodiments of the present disclosure, and are not intended to limit the present disclosure. Any modifications, equivalent replacements and improvements made within the spirit and principle of the present disclosure should fall within the protection scope of the present disclosure.

1. A rotatable plug, comprising a base and a plug portion, wherein the base is electrically connected to the plug portion and the plug portion rotates relative to the base, and the plug portion is provided with a first pin and a second pin; an accommodating cavity is arranged in the base, and the accommodating cavity is provided with a rotating member, a first metal conductor and a second metal conductor, wherein the rotating member comprises a rotating shaft, one end of the rotating shaft is fixed to the base, and the other end thereof is connected to the plug portion; the first metal conductor and the second metal conductor are both of an annular structure and arranged around the rotating shaft as a center; and the first pin extends into the accommodating cavity and is in contact with the first metal conductor, while the second metal conductor extends into the accommodating cavity and is in contact with the second metal conductor.

2. The rotatable plug according to claim 1, wherein the plug portion is further provided with a ground pin, and the accommodating cavity is further provided with a ground conductor, wherein the ground conductor is of an annular structure, and the ground pin extends into the accommodating cavity and is in contact with the ground conductor.

3. The rotatable plug according to claim 2, wherein the second metal conductor, the first metal conductor, and the ground conductor are arranged from near to far in sequence, with the rotating shaft as the center.

4. The rotatable plug according to claim 1, wherein the second pin is fixed on the rotating shaft, the second metal conductor is sleeved on the rotating shaft, and the second pin is in contact with the second metal conductor.

5. The rotatable plug according to claim 1, wherein the first metal conductor is provided with a plurality of elastic members, wherein the elastic members are located below the first metal conductor and arranged along a direction of the first metal conductor; and the first pin extends and is in contact with the first metal conductor, and an elastic support is formed by the elastic members below the first metal conductor, so that the first pin and the first metal conductor contact each other to form a compacted state.

6. The rotatable plug according to claim 2, wherein the ground pin is connected to a metal elastic sheet, and an end of the metal elastic sheet can move along the ground conductor and is electrically connected with the ground conductor.

7. The rotatable plug according to claim 2, wherein the first metal conductor and the second metal conductor are of a closed annular structure or a non-closed annular structure or a crescent-shaped structure, and the ground conductor is of an annular structure.

8. The rotatable plug according to claim 7, wherein the first metal conductor is a non-closed annular conductive sheet.

9. The rotatable plug according to claim 7, wherein the second metal conductor is a non-closed annular conductive sheet.

10. The rotatable plug according to claim 7, wherein the ground conductor is a closed annular conductive sheet.
